(19) United States
(12) Patent Application Publication
(10) Pub. No.: US 2008/0099503 A1
(43) Pub. Date: May 1, 2008

(54) SHOTGUN SHELL STORING AND DISPENSING DEVICE

(75) Inventors: Daniel Altieri, Coopersburg, PA (US); Andrew M. Truxel, Warren, NJ (US)

Correspondence Address: DESIGN IP, P.C., 5100 W. TILGHMAN STREET, SUITE 205, ALLENTOWN, PA, 18104, US

(73) Assignee: DPA Innovations, Inc., Coopersburg, PA (US)

(21) Appl. No.: 11/554,147

(22) Filed: Oct. 30, 2006

(51) Int. Cl. B23Q 7/12

(52) U.S. Cl. 221/156

(57) ABSTRACT

A shotgun shell storage and dispenser in the form of a hollow elongated housing to hold the shells in vertical array for dispensing through a lower end of the housing. Shotgun shells are positioned by structure on a rear wall of the housing which also contains a biased follower to urge the shotgun shells toward the lower end of the housing.

### BACKGROUND OF THE INVENTION

The present invention pertains to the ability of a person engaged in use of a shotgun to have readily an accessible and easily dispensed quantity of shotgun shells. Such persons are normally engaged in law enforcement, the military or sporting endeavors such as skeet shooting, trap shooting and sporting clays.

Shotgun users that wish to carry ammunition in excess of that which is either designated capacity by the manufacturer of a shotgun such as a pump shotgun or an automatic shotgun or is limited by laws or regulations may wish to carry extra ammunition (shotgun shells) that can be readily available and readily dispensed for reloading the weapon.

The extra ammunition can be carried by such devices as a bandolier made from fabric with individual slings or pockets to carry shotgun shells. The bandolier is normally worn across the chest of the user from a shoulder to the waist. A similar device in the form of a belt worn around the waist of the user is also available.

Certain manufacturers offer a cover for a rifle or shotgun sling that can be adapted to carry extra shells. It is also possible to buy a flexible carrier or a rigid carrier that can be removably fastened to the stock of the shotgun to carry extra shells.

Belt patches as well as vests with pouches are also available to carry extra shotgun shells.

U.S. Pat. Nos. 2,837,258; 6,817,135 and 3,219,244 are representative of the state of the art.

### BRIEF DESCRIPTION OF THE INVENTION

The present invention pertains to a shotgun shell storing and dispensing device that is in the form of an elongated hollow housing adapted to receive the shells in a generally horizontal array so that the user can select a shell from a bottom opening of the housing for rapid reloading of a shotgun. The housing includes means to urge the shells from a top or second end to the open bottom or first end of the housing to maintain the shells in position during transport and until the user calls for a shell.

Therefore, in one aspect the present invention is a device for storing and dispensing shotgun shells comprising: a generally elongated hollow housing having a generally rectangular shaped cross-section; the housing adapted to position shotgun shells in a generally vertical array with the longitudinal axis of each of the shotgun shells generally perpendicular to a long axis of the housing between opposite elongated sides of the housing; means on a first or dispensing end of the housing to prevent shells from falling out of the housing and to position each shotgun shell to be dispensed for easy grasp by a user; and biasing means movable between the first and second ends of the housing, the biasing means adapted to urge the shotgun shells toward the dispensing end of the housing.

### BRIEF DESCRIPTION OF THE DRAWINGS

FIG. 1 is an isometric view of an apparatus according to the present invention.

FIG. 2 is a front elevation view of the device of FIG. 1.

FIG. 3 is a left side view of the device of FIG. 1.

FIG. 4 is a top plan view of the device of FIG. 1.

FIG. 5a is an isometric view of the device of FIG. 1 with the front cover removed.

FIG. 5b is an isometric view of the device in FIG. 1 with the front cover, top cover and spring removed.

FIG. 6 is a front elavational view of FIG. 5a.

FIG. 7 is a left side elavational view of the device shown in FIG. 6.

FIG. 8 is a top plan view of the device shown in FIG. 6.

FIG. 9 is a front elavational view showing a detail of the inside back of the device according to the present invention.

FIG. 10 is an enlarged fragmentary isometric view illustrating details of the feed end of the device of FIG. 1.

FIG. 11a is a fragmentary isometric view of the device of FIG. 11 illustrating the cover.

FIG. 11b is a partial fragmentary front view of the device of FIG. 11a.

FIG. 11c is a partial fragmentary left side elavational view of the device of FIG. 11b.

FIG. 12a is a fragmentary isometric view illustrating a function of the cover of the device of FIG. 1.

FIG. 12b is a partial fragmentary front elavational view of the device of FIG. 12a.

FIG. 12c is a left side view of the partial fragmentary left side view of the device of FIG. 12b.

FIG. 13 is a side elavational view of an alternative embodiment of the device of FIG. 1.

FIG. 14 is a left side elavational view of an alternate embodiment of the device of FIG. 1.

FIG. 15a is a front elavational view of yet another embodiment of the device according to the present invention.

FIG. 15b is a back elavational view of the device of FIG. 15a.

FIG. 16 is perspective view of an alternate embodiment of an apparatus according to the present invention.

FIG. 17 is a front elavational view of the device of FIG. 16.

FIG. 18 is a left side elavational view of the device of FIG. 16.

FIG. 19 is a top view of the device of FIG. 16.

FIG. 20 is a front elavational view showing a detail of the inside back of the device according to the invention.

FIG. 21 is a perspective view of the device of FIG. 16 with the front cover removed showing interior details of the device.

FIG. 22 is a front elavational view of the device of FIG. 21 with the front cover removed showing interior details of the device.

FIG. 23 is a left side elavational view of the device of FIG. 22.

FIG. 24 is a perspective view of the follower of the device of FIG. 22.

FIG. 25 is a front elavational view of the follower of FIG. 24.

FIG. 26 is a bottom view of the follower of FIG. 24.

### DETAILED DESCRIPTION OF THE PREFERRED EMBODIMENTS

Referring to FIG. 1 a shotgun shell carrying and dispensing device 10 according to one embodiment of the present invention has a housing 12 having a front or face portion 14 and a rear portion 16. The housing 12 can also be molded as a one piece unit.

The device 10 also includes a clip, loop or other mechanical device generally illustrated as 18 so the user can fix the device 10 to an article of clothing such as a belt. Any of the known devices for attaching accessories or tools to the belt or clothing of a user can be adapted for this purpose. Device 10 can also be adapted to be carried by the stock of the shotgun. The device 10 includes a cover 20 on a top or second end 21 of the housing 12 and a thumb or finger grip 22 on a bottom or first end 23 of the housing 12 to aid the user in dispensing a shell or shells.

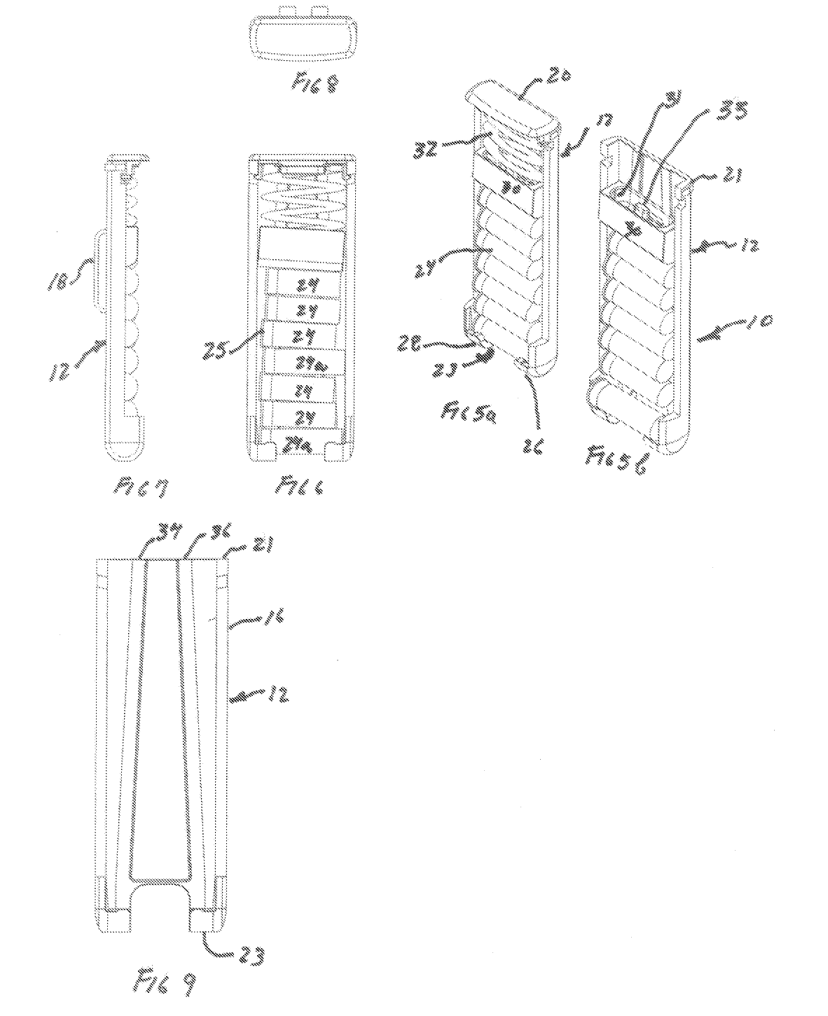

As shown in FIG. 5a, the front cover 14 has been removed from the housing 12 to illustrate interior details thereof.

As shown in FIG. 5a, a plurality of shotgun shells, one of which is illustrated by the numeral 24, are arrayed generally horizontally (relative to a vertical axis through the long dimension of the housing 12) from the first or dispensing end 23 to the cover or second end 21 of housing 12. The shotgun shells are maintained inside of the housing 12 by means of the hook or rounded portions 26, 28 associated with a first, (discharge or dispensing) end 23 of the housing 12. The housing includes a follower 30 which is disposed between the shotgun shells 24 and the top of the housing 12. Between the follower and the top of housing 12 and positioned by cover 20 is a biasing means 32 which serves to urge the follower 30 against the shotgun shells 24 and move the shotgun shells downwardly as one is extracted through the end 23 of the housing 12. FIG. 5b illustrates the details of the follower 30 showing a recess 31 and post 33 to position and retains a spring or biasing device 32 within the housing, the top 20 being removed for clarity.

As shown in FIG. 6, the shotgun shells 24 can be loaded with the rim of each shotgun shell 25 placed on the same side of the housing, the slight angular disposition of the shotgun shells will not cause the shotgun shells to jam or not move down in the housing 12.

Shown in FIG. 7 the shotgun shells are kept in a generally horizontal position in a vertical array.

Referring to FIGS. 5a, 5b and 6, a user can place his or her hands underneath the end 23 of the housing 12 and readily grip a shotgun shell for extracting from the device 10 for rapid deployment into the chamber of shotgun.

Referring to FIG. 9, the housing portion 16 contains a pair of rails or vertical projections 34, 36 which help position the shotgun shells for ready movement down the device 10 to the dispensing end 23. The rails 34, 36 are positioned so that various lengths of shells of a given gage can be held in the housing as illustrated in FIG. 6 where shells 24a are of a longer length than shells 24. Users thus can load shells of varying lengths without fear of shotgun shells jamming inside of the housing.

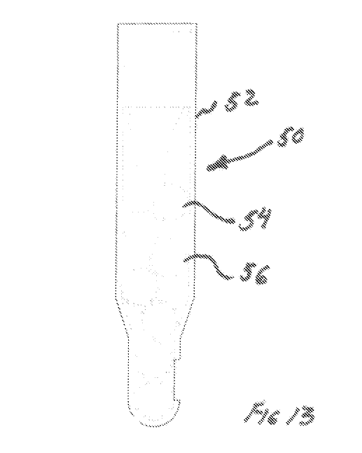

FIG. 10 illustrates the device 10 having a ridge or thumb holder 40 located to assist the user in extracting shells from the device 10. As shown in FIGS. 11a, 11b and 11c, a protective cover 38 is slideably disposed in the front 14 of the housing 12 and can be moved downwardly to protect the shotgun shells so they are not prematurely ejected from the housing 12 should the apparatus 10 be violently jostled.

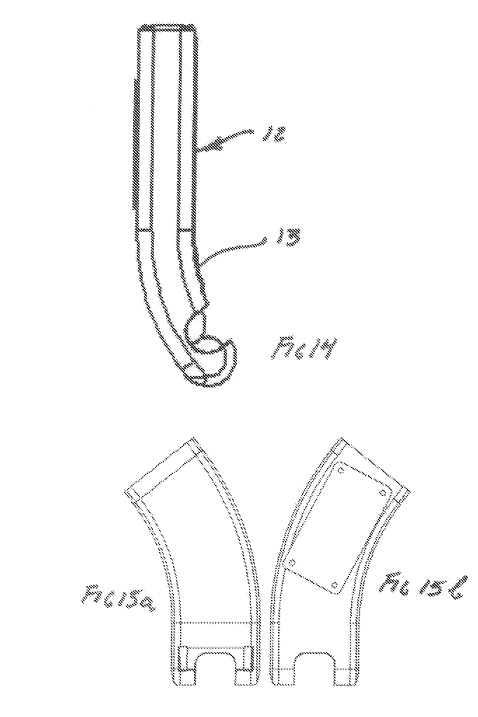

FIGS. 12a, 12b and 12c illustrate the protective cover 38 in a retracted position as shown by the dotted lines, e.g. 42 in FIG. 12b. Although specifically not illustrated in detail, the protective cover 32 is fastened to the front portion 14 of device 10 through a groove or slot 39 in the protective cover, as would be apparent to a worker skilled in the art.

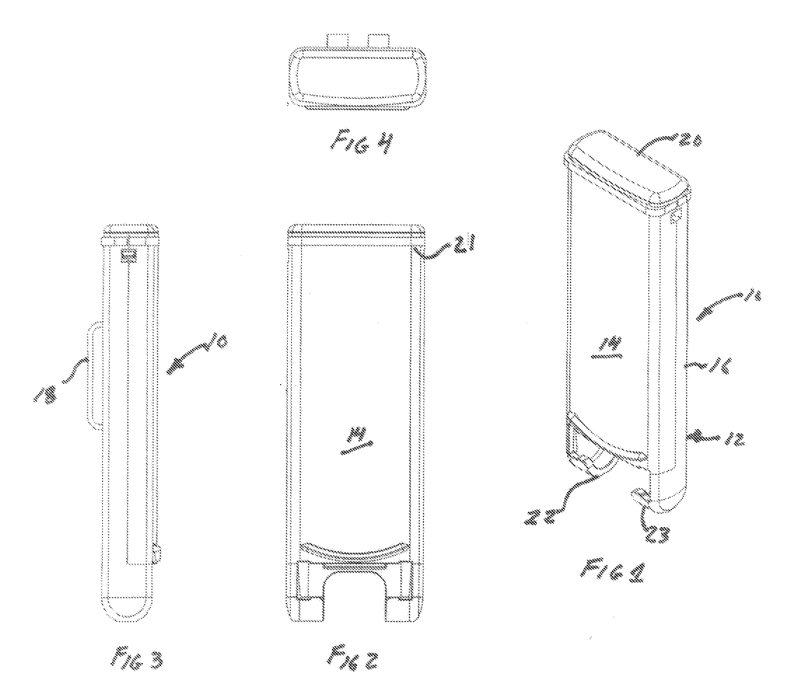

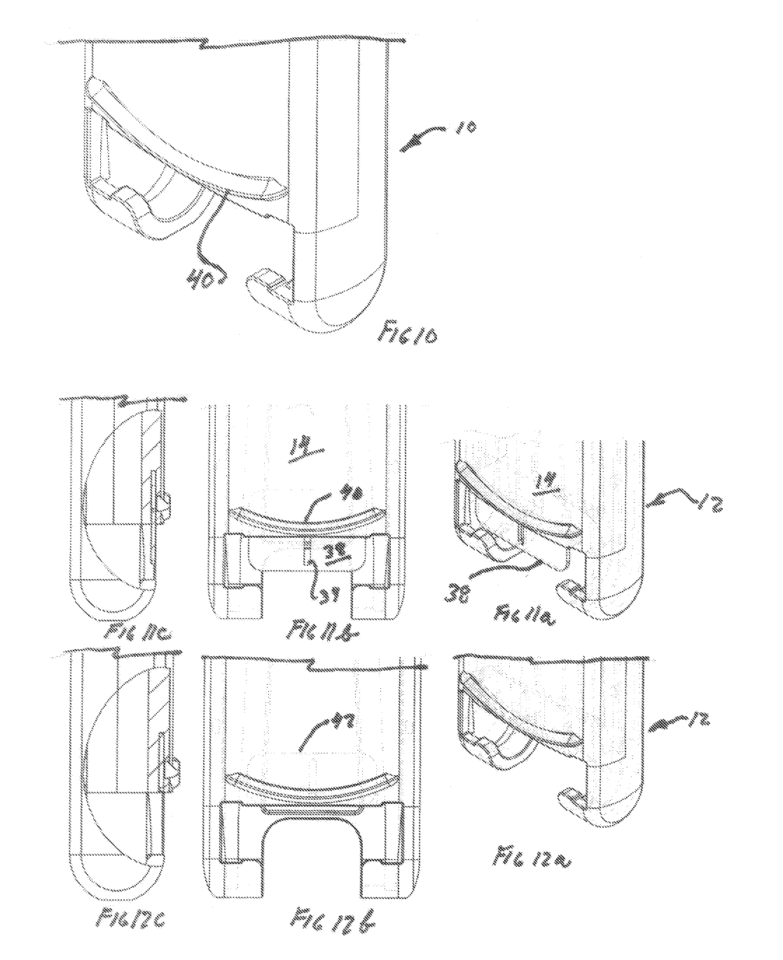

Referring to FIG. 13 another embodiment to the invention is shown generally as 50 which includes a thicker housing 52 to hold and dispense a larger number of shotgun shells 54, 56 which are disposed in alternating sequence as illustrated by ghost lines in FIG. 13. All other features of the device such as sown in FIG. 13 would be similar to the device of FIGS. 1 through 12c.

FIG. 14 is an illustration of an alternate embodiment where a lower portion 18 of the housing 12 is curved so it projects away from the upper portion of the housing 12.

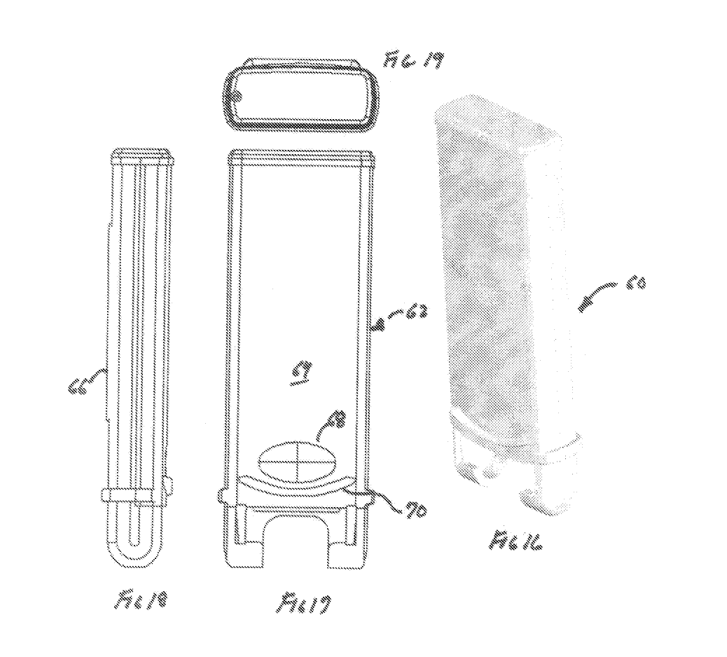

FIG. 15a is front view of and FIG. 15b is a back view illustrating a device according to the present invention where the housing 12 can be curved in a direction other than vertical to accommodate either equipment features or uniform features of a user.

A device according to the present invention is adapted to hold and dispense different gages of shotgun shells (e.g. 20, 12, 10 gauge). The number of shotgun shells that can be held and dispensed can be varied from 1 to 25 depending upon the length of the housing 12.

Referring to FIG. 16 an alternate embodiment of the invention 60 has all the outward appearances of the device of FIGS. 1-15. The case 62 includes a front portion 64 and a back portion 66 as described above. Front portion 64 of case 60 can include a recess 68 above the ridge or finger prop 70 to aid in the comfort of extracting shotgun shells from the case 60.

Referring to FIG. 20 the back portion 66 of the case 60 includes at least two rails 72, 74 to aid in positioning the shotgun shells 76 within the case 60.

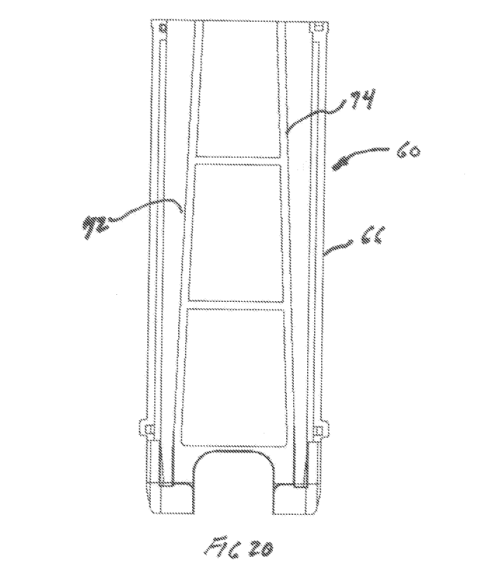

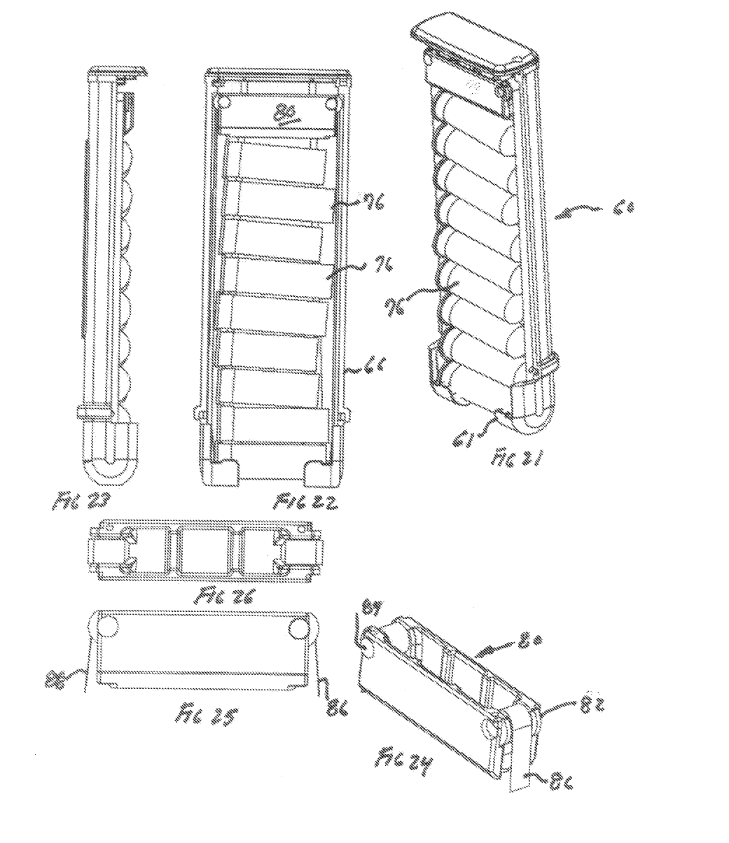

Referring to FIG. 21 the device or case 60 is shown with shotgun shells 76 positioned in a manner similar to that shown with the apparatus of FIGS. 1-15. The difference between the embodiment of FIGS. 1-15 and FIGS. 19-25 is the follower 80 shown in detail in FIGS. 23-25. Follower 80 is made to include a pair of rollers or shafts and rollers 82, 84 which support flexible ribbons 86, 88. Ribbons 86, 88 are made to roll about the axis of rotation of rollers and shafts 82, 84 and extend from the follower 80 to a location proximate the bottom of the back portion 66 of case 60 as shown in FIG. 22. Thus when the shotgun shells 76 are placed into the case through the bottom portion 61, the follower 80 will be urged upwardly toward the top 63 of case 60. The follower 80 will then exert pressure on the shotgun shells 76 so that as a shotgun shell is removed through the bottom 61 of the case 60, the remaining shotgun shells in the case 60 are urged downwardly and are maintained in position by the follower 80 in a manner similar to that which is disclosed in relation to FIGS. 1-15.

A device according to the present invention can be fabricated as a solid structure to be weather proof and water proof and to protect the shotgun shells. With few moving parts a case according to the invention will have increased use and durability.

A device according to the present invention can be used by either a right or left handed shotgun user.

A device according to the present invention does not require special structure, e.g. grooves on the inside side walls of the case to grip the rim of the shotgun shell in order to maintain the vertical array of the horizontally disposed shotgun shells. A device according to the embodiment of FIGS. 1-12b can be loaded from either top or bottom of the housing, and can be readily opened for cleaning and maintenance. A device according to the embodiment of FIGS. 16-25 has a removable lid for servicing but is loaded and unloaded through the bottom of case 60.

In a preferred embodiment the curved dispensing fingers 26, 28 (FIG. 5a) can be constructed to support half the length of one shotgun shell. The width of the dispensing gap occurring between the top edge of the curved region and the bottom edge of the front wall of the housing 12 is arranged to be large enough for only one shotgun shell to dispense at a time and is positioned so that when the dispenser is not being accessed, the bottom shotgun shell and those above it are held in position. Thus no shotgun shell leaves the device without the upward/outward motion required to dispense the shotgun shells.

The forgoing description provides illustrative embodiments of the present invention, and is not intended to limit the scope, applicability, or configuration of the invention. The description of the embodiments of the invention will provide those skilled in the art with an enabling description for implementing the invention. It should be understood that various changes may be made in the function and arrangement of elements without departing from the spirit and scope of the invention.

Having thus described our invention what is desired to be secured by Letters Patent of the United States is set forth in the appended claims.

1. A device for storing and dispensing shotgun shells comprising:
a generally elongated hollow housing having a generally rectangular shaped cross-section, a first and second end, said housing having means to position shotgun shells in a vertical array with the longitudinal axis of each of said shotgun shells generally perpendicular to a longitudinal axis of said housing;
means on said first end of said housing to permit dispensing of shells and to prevent shells from falling out of said housing while positioning successive shotgun shells to be dispensed for easy grasp by a user; and
means to urge said shotgun shells toward said first end of said housing, said means disposed between said second end of said housing and an uppermost one of said shotgun shells arrayed in said housing.

2. A device according to claim 1 wherein said means to urge said shotgun shells includes a follower positioned by a pair of flexible ribbons, each of said ribbons extending from a location proximate said first end of said housing to a roller on said follower inside said housing.

3. A device according to claim 1 wherein a front wall portion of said housing extends from said second end to a position above said first end of said housing.

4. A device according to claim 1 wherein said means to urge a said shotgun shell includes a follower means positioned adjacent an uppermost shotgun shell in said array; said follower means biased against a removable cap on said second end of said housing.

5. A device according to claim 1 wherein said housing is adapted to hold two or more rows of vertically arranged shotgun shells.

6. A device according to claim 1 wherein said housing has a vertical portion and a lower curved portion projecting forward of said vertical portion.

7. A device according to claim 1 wherein said housing is continuously curved from said first end to said second end.

8. A device according to claim 1 wherein said means to position said shotgun shells in said housing consists of a pair of raised guide rails on a back wall portion of said housing.

9. A device according to claim 1 including means to attach said housing to an article of clothing worn by a user.
